(19) United States
(12) Patent Application Publication
(10) Pub. No.: US 2023/0166653 A1
(43) Pub. Date: Jun. 1, 2023

(54) LIGHT INDICATOR OF DIRECTION

(71) Applicant: GALAXI S.R.L, Serravalle (SM)

(72) Inventors: Nicola Faggionato, Piove di Sacco (PD) (IT); Corrado Faggionato, Padova (IT)

(73) Assignee: GALAXI S.R.L, Serravalle (SM)

(21) Appl. No.: 17/921,669

(22) PCT Filed: Mar. 30, 2021
(86) PCT No.: PCT/IB2021/052599

§ 371 Date: Oct. 27, 2022

(30) Foreign Application Priority Data
Apr. 27, 2020 (IT) 102020000008809

(51) Int. Cl. B60Q 1/34; B60W 50/10

(52) U.S. Cl. CPC B60Q 1/343; B60W 50/10

(57) ABSTRACT

The present invention relates to a safety system device for the benefit of cyclists, and in general of all drivers of two and three-wheeled and it can also be used by runners, when they circulate in the streets.

The invention comprises a light indicator that is suitable to signal, when a cyclist makes a change of direction, and the rider tries to signal this maneuver by moving outwards the arm corresponding to the side towards which the direction of travel is changing.

This device integrates: a lighting element designed to switch on and off according to an appropriate electrical command, an electrical power supply unit, a triaxial accelerometer and an inclinometer sensor. It also comprises calculation means for processing the signals supplied by the triaxial accelerometer and the inclinometer sensor, carrying out an interpretation of the meaning of the movement of the arm.

### BACKGROUND OF THE INVENTION

### 1. Field of the Invention

The main field of application of the present invention relates to safety systems for the benefit of cyclists, and in general of all drivers of non-registered two and three-wheeled vehicles (e.g., bicycles, scooters, electric bikes, etc.), when they circulate in the streets. In particular, a light indicator is proposed that is suitable to signal, more clearly, when a cyclist makes a change of direction, and he tries to signal this maneuver by moving outwards the arm corresponding to the side towards which the direction of travel is changing.

The invention is also applied as a useful equipment for runners. In fact, the practice of running is a numerically growing phenomenon, and it is often practiced along routes also used by other vehicles, and in which it is useful to increase one's visibility.

### 2. Brief Description of the Prior Art

Every day, a large number of cyclists travels on roads where other motor vehicles circulate, sometimes even in large numbers, and at high speeds; with the risk that cyclists are involved in accidents.

The safety of cyclists is a topic of great importance, as, in the event of an accident, even when these occur at low speed, the cyclist is often the victim of very serious injuries and, in many cases, unfortunately, also loses his life. It is evident that the cyclist cannot have the same physical safety protections that can be provided to the occupants of other vehicles. The physical protections that can be used by a cyclist are very limited; ranging from lightweight helmets, elbow pads and knee pads, to reinforced gloves for hand protection in the event of a fall: in some cases, but only in the case of cyclists engaged in sports, cyclists wear spinal protectors, but hardly such precautions they are used by the strolling cyclist or by the cyclist who uses this vehicle for his own movements. In general, however, in all cases, these are protections that can certainly limit damage in the event of a fall, but they are often ineffective in the event of an accident with another vehicle. Furthermore, these are uncomfortable protections, especially if you think that the bicycle should be a simple and essential means of transport, to be used freely, without having to worry about being equipped with particular physical protections (and uncomfortable to wear) every time you use this means of transport. The result is that only a small part of cyclists makes regular use of these physical protections.

Especially those who use the bicycle as a means of urban transport must be able to use it without having to wear specific equipment which, among other things, is quite bulky when it has to removed, since it is not suitable to be worn when engaged in other activities, such as when you are at work.

It is therefore essential to take action to reduce the risk of accidents involving cyclists.

To achieve this, the market offers bicycles equipped with flashy lights, to improve their visibility, or cyclists can use fluorescent or even luminous clothing, again to improve their visibility. In the latter case, the market offers bands that can be worn on the arm or applied to the torso or back. Unlike physical protection devices, these bands are not rigid, they can be removed or worn easily and, when not in use, they are not bulky and can be stored in a bag or a pocket: from this point of view, they are certainly suitable for a large number of cyclists.

Among the garments aimed at increasing the visibility of cyclists, it has been said that there are luminous bands capable of emitting light. This is possible thanks to the increasing efficiency and small dimensions of the LED technology: it is a low-energy-consumption technology, while being able for emitting a significant light, so that even the necessary power can be supplied by very small batteries with a considerable duration (also corresponding to many hours of ignition).

With reference to the light devices proposed by the market, however, it is noted that these must be switched on and off by the cyclist. It is a simple operation, as it is simple the operation of turning on the bicycle lights, but this last operation has to be done just at the start and finish, not during, the run.

The market does not offer bicycles with lights suitable for indicating changes of direction: the so-called direction indicators, which are instead present in many other vehicles, including some motorcycles. The cyclist, in fact, should manually turn on any light to indicate the change of direction, and then he should remember to turn it off: this is a task that would probably be used little in practice.

Although the use of luminous direction indicators, which indicate a cyclist's intentions to turn or move sideways, would be extremely useful, and would allow to avoid some accidents, the circulating bicycles do not use any luminous signaling devices for changes of direction: probably because it is believed that such devices would not be used regularly by cyclists.

The most common behavior of a cyclist, to indicate his intention to change direction, is to detach his hand from the handlebar, at the side to which he intends to change direction, and to stick his arm out to the side.

This is a very common maneuver, which many cyclists perform spontaneously, but which is not always visible with the necessary evidence. It would therefore be interesting to equip cyclists with a device to be worn very close to the hand, for example on the wrist, which lights up when the cyclist protrudes his arm to express his intention to change direction.

For all the observations made, it would be important not to have to require the cyclist to wear something uncomfortable or bulky, nor to have to ask him to remember to turn the light on or off by acting on a command. Only in this way it can it be reasonably hypothesized that such a luminous device could be welcomed by a large number of cyclists, and used effectively.

### SUMMARY OF THE INVENTION

The general purpose of the present invention, therefore, is to indicate an innovative luminous device that can be worn by a cyclist on the wrist, or in any case near the hand, which turns on automatically only when the cyclist makes the natural gesture of pointing with his hand, by detaching it from the handlebar, his intention to make a change of direction.

A further object of the present invention is that said innovative luminous device, wearable by a cyclist, is particularly small and light so that it does not constitute a hindrance, having to carry it around when not in use.

Furthermore, a further purpose of the present invention is that said innovative luminous device, wearable by a cyclist, is particularly easy to wear, not having to pay attention to the orientation with which it is worn.

A secondary purpose is to indicate a version of this innovative luminous device, so that it can also be used by those who practice running.

The scopes set for this invention are achieved by using a light indicator of direction (for cyclists or for drivers of other vehicles with similar characteristics or, as an extreme case, also by runners) suitable to be worn close to the hand and equipped at least with the following components:

a. a lighting element designed to turn on and off as a function of a suitable electrical command,

b. an electrical power supply unit,

c. a triaxial accelerometer, suitable to provide a vector signal indicative of the acceleration vector to which said triaxial accelerometer is subjected,

d. an inclinometer sensor rigidly coupled to said triaxial accelerometer, designed to provide a signal indicative of the inclination of its own axis with respect to the vertical,

e. computing means able to process said signals provided by said triaxial accelerometer and by said inclinometer sensor, and able to produce an electrical command for switching on and off said lighting element;

and computing means are configured for:

f. executing a calculation program that determines the acceleration to which said triaxial accelerometer is subjected, expressed in a reference system oriented regardless of how said triaxial accelerometer is oriented,

g. executing a calculation program that generates a command to switch-on said lighting element as a function of said acceleration determined in the previous point “f.”

In particular, such a light indicator of direction for cyclists must switch-on all, and possibly only, the times when a cyclist moves his arm, taking his hand away from the handlebar, to indicate his intention to change the travel direction, keeping the behavior that the more it comes naturally to him, with absolute spontaneity.

The functioning must be the correct one, without having to require that the cyclist pays attention to the way in which he wears this device, except for the fact of asking him to wear the right device near the right hand, and the left device near the left hand.

Furthermore, the cyclist must not be required to adopt any particular movement, nor to pay attention to how he performs the movement, which must be absolutely spontaneous. For example, the back of the hand can be oriented in any way during movement: upwards, like downwards or outwards. As well as the position of the hands on the handlebar (i.e., the starting position of the gesture performed by the cyclist) can be oriented in any way, depending on the shape of the handlebar: for example, the handlebars of racing bikes are different from those of urban bikes, and they can provide more than one position where to hold the hands, providing different orientations of the wrist and hand.

As will be clarified below, said luminous indicator of direction can also be made in a version for runners.

The main advantage of the present invention is given by the fact that a luminous indicator of direction made according to the teachings of the present invention allows to satisfy all the purposes for which the invention was conceived.

### BRIEF DESCRIPTION OF THE DRAWINGS

This invention also has further advantages, which will become more evident from the following description, from some examples of practical embodiments which illustrate further details, from the attached claims which form an integral part of the present description, and from the attached figures in which:

FIG. 1 shows, schematically, a form of implementation of a light indicator of direction according to the invention, in which the main elements that constitute it are highlighted;

FIG. 2 shows the two main reference systems that must be considered to perform the necessary computing for the correct functioning of the light indicator of direction according to the invention;

FIG. 3 shows an essential flow chart that summarizes the main processing steps that can be performed for the correct operation of a light indicator of direction according to the invention.

### DETAILED DESCRIPTION OF THE INVENTION

The following description is developed with reference to the case of an luminous indicator of direction for cyclists, however, the same device can also be worn, for the same purposes, by drivers of other non-registered two and three-wheeled vehicles, such as for example electric bicycles, scooters or tricycles. Furthermore, as a borderline case, the device can also be worn by runners.

The following description therefore remains valid also for these other cases, and only where some details of the device must be specialized (this is the case of the version of the device for runners), which differences that must be implemented will be indicated.

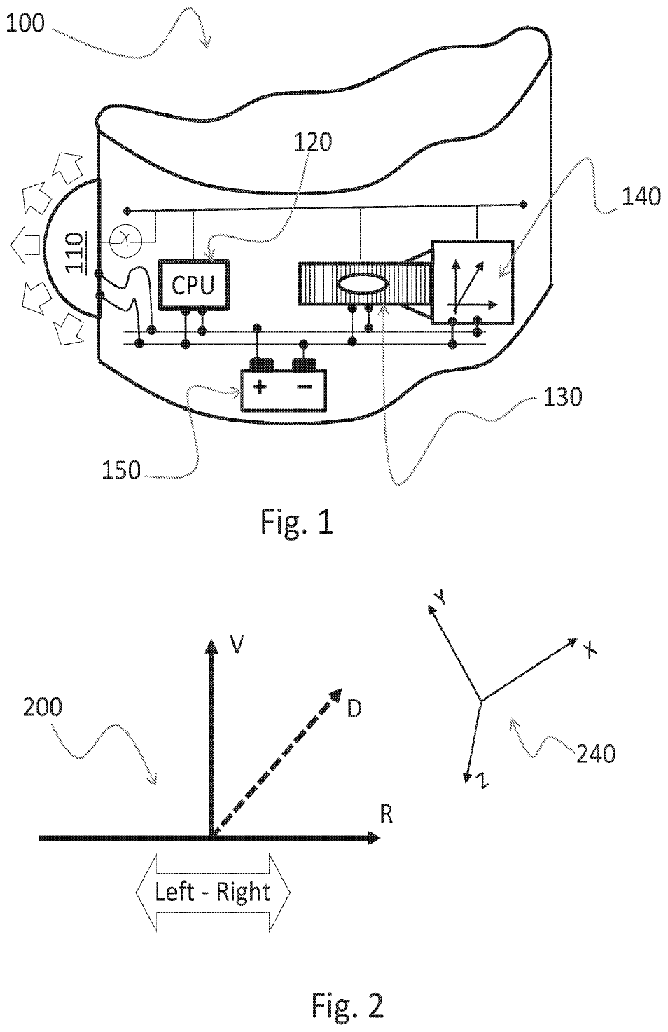

FIG. 1 presents the basic scheme of a luminous indicator of direction for cyclists according to the invention, which is indicated as a whole with the number 100 and which, by way of example, is imagined as a wristband. It is specified from the outset that the choice of integrating said luminous direction indicator for cyclists 100 in a wristband is only one of the possible choices, which allows the creation of a device that is very agile to wear and not very bulky when not used, so that it can easily be stored in a purse or even in a pocket. Other forms of implementation can be conceived, for example, in a pair of cycling gloves, or in the terminal part of the sleeves of a jacket or jersey to be proposed to the market of the cyclists.

It is also noted that the device does not require special attention when it is worn: the only precaution that must be observed is to wear the left device near the left hand and the right device near the right hand. It is clear that this attention makes sense in the case of implementation of the device on the cuff, while in the implementation on gloves or sleeves, it is evidently automatic to wear the devices correctly.

FIG. 1 indicates the main components of said luminous direction indicator for cyclists 100.

The actual lighting element is indicated with the number 110. In the preferred forms of implementation, at the state of the art, it is a LED (Light Emitting Diode) element, preferable for its prerogatives of miniaturization, lightness, mechanical resistance (it is not subject to break), and low consumption. However, should the technological landscape propose, in the near future, other technologies equally suitable for the application, these could be used as a lighting element 110, for the implementation of the present invention.

Said lighting element 110 can have various shapes and it can be arranged in a distributed way, for example all around the cuff (in the case of cuff implementation), or it can consist of two or three luminous points placed so as to emit light in diverging directions, so as not to require the cyclist to pay attention to the positioning of the lighting element 110. In fact, these LED luminous devices are so small and cheap that it is absolutely no problem to use a plurality of LEDs to be arranged with great flexibility to produce said luminous indicator of direction for cyclists 100. Alternatively, in the event that it is desired to use a concentrated lighting element 110, with only one small area that lights up, the cyclist must take care to position it in such a way that it is visible when he raises his arm to indicate his intention to make a change of direction. Once again, this attention is superfluous in the case of implementation of the invention on gloves or sleeves, as the way in which these are worn is limited to a single position.

A further, very important, element of said luminous indicator of direction 100 for cyclists is constituted by suitable computing means, indicated in FIG. 1 with the number 120. Said computing means 120 are arranged to receive input data from suitable sensors, and to produce an on and off command for said lighting element 110. The sensors from which said computing means 120 receive input data are two: an inclinometer sensor, indicated in FIG. 1 with the number 130, and a triaxial accelerometer sensor indicated in FIG. 1 with the number 140.

These two sensors, inclinometer 130 and triaxial accelerometer 140, have the characteristic of being rigidly integral with each other. In particular, the inclinometer 130 must not vary its inclination with respect to the triaxial accelerometer 140: so that the inclination of the inclinometer 130 is also representative of the inclination of the triaxial accelerometer 140.

It is noted that these types of sensors are also widely available; they are sensors based on reliable, low consumption and small size technologies. Their technological maturity has rapidly consolidated in recent years as it is driven by applications in the video gaming sector, for which they constitute an essential technology, necessary for the creation of user interfaces, capable of capturing, in real time, some physical movements made by players. Therefore, compact sensors are also available that integrate in a single device the inclinometer function and the triaxial accelerometer function: that is, they provide a signal indicating the inclination with respect to the vertical of a reference system integral with the sensor itself, and a vector signal indicating the acceleration which the sensor is subjected to.

For the purposes of the description of the present invention, reference will be made to two rigidly coupled sensors, knowing that it is still possible to implement the present invention even with a single sensor capable of returning both the pieces of information required for the implementation of the invention itself.

Finally, and for the sake of completeness, in FIG. 1 the number 150 indicates a power supply element, essential for powering the other elements previously mentioned. Even the technology used for this power supply is not the subject of the present invention, therefore it is possible to choose among the numerous technologies that can satisfy the task of powering the components necessary for the implementation of the present invention.

It is only observed that the energy requirement is quite low, and therefore batteries of reduced size and sufficient capacity to satisfy the purposes of the present invention are available.

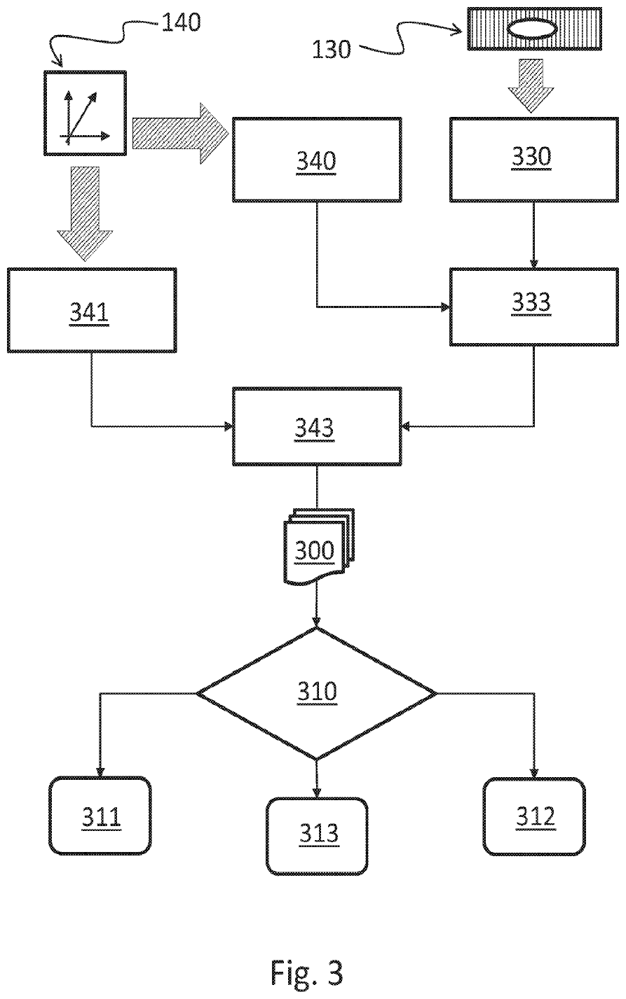

Before describing, in detail, how the information produced by sensors 130 and 140 can be used (description which will be provided later with the aid of FIG. 3), it is observed that the orientation of said two sensors, when said luminous direction indicator 100 is worn by a cyclist, it is not predictable, as it depends on the shape of the bicycle handlebar, on how the cyclist holds it, and if he holds it with both hands (that is not obvious, even if cyclists should drive their vehicle by holding the handlebar with both hands).

Therefore, emerges the importance of determining, with a good approximation, the orientation of the reference system with respect to which the accelerometer sensor 140 provides the vector information, which, in turn, allows to reconstruct the movements of the cyclist's hand,

FIG. 2, represents the two reference systems which are significant for illustrating the operation of the present invention. The number 240 indicates a reference system integral with the triaxial accelerometer sensor 140. As noted above, it is not possible to predict with sufficient approximation how this sensor is oriented with respect to the external environment.

In fact, the cuff, if the invention is implemented by a cuff, can be worn in at least two ways (with two different orientations); and even if the invention were implemented by an object a wearable in just one way, such as a glove, it is not possible to determine with sufficient precision the orientation of this accelerometer sensor 140, due to the different positions with which a cyclist can keep his hands on a handlebar.

It is evident that the knowledge of the hand movement, with respect to a reference system whose orientation is not known, does not allow to interpret this movement as the will to signal a change of direction.

The most important reference system for carrying out a correct interpretation of the cyclist's hand movement is the reference system indicated in FIG. 2 with the number 200, associated with the running of the bicycle and therefore, indirectly, associated with the bicycle. Said reference system 200 has a first axis, indicated as “D” axis, oriented according to the run of the bicycle, and a second axis, indicated as “V” axis, oriented according to the vertical. If the bicycle travel is on a horizontal plane, the two axes, “D” and “V”, are orthogonal, if the bicycle travel is on a slope (uphill or downhill), the “D” axis will result from the shortest rotation of the direction of travel of the bicycle, on the plane determined by the vertical axis and the direction of travel of the bicycle, so that the two axes “V” and “D” are orthogonal.

Once two oriented orthogonal axes have been fixed, the reference system 200 may be uniquely determined; and the third axis, indicated as the “R” axis, will automatically indicate positions to the right of the bicycle, for positive values of the coordinate on “R”, or positions at left, for negative values of the coordinate on “R”.

It is clear that in the event that the device is worn by a runner, it makes no sense to seek the orientation of the reference system associated with the bicycle (since the bicycle is not there). However, it is still essential to define a reference system such as the reference system 200, with the only difference that the “D” axis will be oriented according to an estimate of the runner's running direction.

Assuming a device with the essential components indicated in FIG. 1, and making use of the reference systems indicated in FIG. 2, it is possible to explain how said luminous direction indicator 100 according to the present invention can work, using the block diagram of FIG. 3.

FIG. 3 schematically presents an essential flow diagram, which summarizes the processing carried out by said computing means 120 which are included in said luminous indicator of direction 100 for cyclists.

The data produced by said triaxial accelerometer sensor 140 are indicative of the acceleration of the sensor 140 itself, and therefore allow to reconstruct the motion trajectory of the sensor 140 expressed in the reference system 240 integral with the sensor.

By means of a relatively long observation (of several seconds) of this trajectory of motion, it is possible to estimate the direction of the bike's motion, this direction must then be kept updated through continuous acquisitions of the information received from said sensor 140.

The computations indicated in block 340 consist precisely in providing an updated output of data about to the motion of the bicycle, and they estimate, in an absolutely plausible way, the direction of the motion of the bicycle. The output of processing block 340 is a data regarding the direction of the bike's motion and therefore allows you to determine the orientation of the “D” axis of the reference system 200, with respect to the reference system 240.

Said processing block 340 constitutes the main difference between the luminous direction indicator 100 in the version for runners, compared to the versions for all other means. In fact, the motion of bicycles is typically on much smooth trajectories, and when the hand is on the handlebar, the motion of the hand differs little from the motion of the bicycle, consequently the implementation of the processing block 340 is much simpler and the result is certainly obtainable faster.

In the case of the luminous direction indicator 100 in the version for runners, the processing block 340 is more complex because the movement of the hand with respect to the body introduces much more noise, and the running path is more difficult to extract. However, using different calculation models, certainly more complex, and longer observations, it is possible to extract the main direction of running, and determine the orientation of the “D” axis of the reference system 200, with respect to the reference system 240, even in the case of devices for runners.

The data produced by the inclinometer sensor 130, on the other hand, are processed by the processing block 330. In this case, it is a very simple processing, as it outputs a data on the direction of the vertical with respect to the inclinometer sensor 130, which, being integral with the accelerometer sensor 140, it allows to determine the orientation of the “V” axis of the reference system 200, with respect to the reference system 240.

Having the outputs of the two processing blocks 340 and 330 which define the axes “D” and “V” of the reference system 200, by means of the processing block 333 said calculation means 120 can determine the formulas for transforming any kinematic quantity initially expressed in the reference system 240, it in the reference system 200, associated with the motion of the bicycle.

The data produced by the accelerometer sensor 140 undergoes a further processing, indicated in FIG. 3 with the processing block 431. Said processing block 341 analyzes the data expressive of short movements, corresponding to movements of the hand with respect to the bicycle (obviously the cyclist's hand cannot move too far away from the bicycle), and it produces, at output, data expressive of short movements of the hand, and said short movements are obviously expressed with respect to the reference system 240 integral with the sensor 140. These short movements of the hand, could represent the gesture of a cyclist to express his intention to make a change of direction, but they could also be movements made for other reasons. In order to correctly interpret the meaning of these short movements, it is necessary to express these data, relating to said short movements, in the reference system 200 associated with the bicycle. This is possible through the processing carried out by the processing block 343, which, using the transformation formulas calculated by the processing block 333, and applying them to the short displacement data produced by the processing block 341, outputs data regarding the short movement of the cyclist's hand; being these data expressed in a reference system associated with the bicycle, such as the reference system 200: the data produced by the processing block 343 is indicated in FIG. 3 with the number 300, and describes the movement of the cyclist's hand with respect to the bicycle.

Therefore, this short displacement datum 300 can be analyzed and interpreted by means of a decision block indicated with the number 310. In particular:
if the short displacement 300 coming from the luminous direction indicator 100, worn on the right hand, has a significant component (in absolute value above a suitable threshold) on the positive “R” axis, i.e., corresponding to the right side of the bicycle, said computing means 120 produce a command for switching on the lighting element 110, and execute the alternative processing block 311;
if the short displacement 300 coming from the luminous direction indicator 100, worn in correspondence with the left hand, has a significant component (in absolute value above a suitable threshold) on the negative “R” axis, i.e., corresponding to the left side of the bicycle, said calculation means 120 produce a command for switching on the lighting element 110, and execute the alternative processing block 312;
in all other cases said calculation means interpret the movement as a movement not expressing the intention of the cyclist (or in any case of the wearer of the device) to signal a change of direction and they do not produce any command towards the lighting element 110, and execute the alternative processing block 313.

While the alternative processing block 313, for the purposes of the present invention, is extremely simple and just consists in discarding the data 300, the other two alternative processing blocks 311 and 312 provide for some further operations. In fact, said luminous element 110 must remain lit as long as the hand is extended, and must be turned off when it is retracted and, as normally happens, repositioned on the handlebar (in the case of the cyclist).

Evidently, the switch-off command can also be generated, like the switch-on command, by processing the data produced by the two sensors 130 and 140 (which continue to produce data), so that the so-called short hand movements can continue to be expressed in the reference system 200 associated with the direction of travel. For the purpose of switching-off, the interpretation of the hand movement data can be facilitated in some ways, since the movement of the hand is predictable (the cyclist does not keep the arm extended externally for too long), but it can also be more complicated, due to the fact that the reference system 200 can change orientation quickly in this phase of the travel, and it may not be very fast to reconstruct it through the processing block 333. However, the timeliness of switching-off the light element 110 is certainly less important than it is for its switching-on; in theory, the shutdown could also be programmed, very simply, to take place after a predetermined period of time, without therefore requiring all the complexity of the previously described processing.

Variations and Concluding Remarks

Ultimately, the luminous direction indicator 100, made according to the teachings of the present invention, appears to be very effective for improving the visibility of cyclists during a potentially dangerous maneuver, such as the execution of a change of direction. Furthermore, the luminous direction indicator 100 also provides information that can be easily understood by all the subjects who are circulating in the vicinity of the cyclist who makes use of the invention, and this is possible without requiring the cyclist to assimilate new driving habits, and without asking him to remember to manually operate a direction indicator (as happens in other vehicles equipped with such light devices).

It is also important to point out, in all generality, that the present invention lends itself to numerous variants, while maintaining the claimed prerogatives.

Some of these variants have already been mentioned, as they consist in integrating the luminous direction indicator 100 into different wearable objects: examples of gloves, cuffs or sleeves of jackets or sweaters have been made, but others items, wearable near the hands, are not excluded.

Furthermore, the invention can be developed in different dimensions and, as already mentioned, it can be based on different technologies, both to realize the lighting element 110, and to implement the required sensors, and also as regards the power supply of the various elements.

The invention itself can be realized partially, as well as the reciprocal position with which the various elements described are arranged can be modified; moreover, each element can be developed in different materials, shapes or sizes and many of the details described can be replaced by technically equivalent elements.

In particular, the indication of the materials, with which said luminous direction indicator 100 is made, is not an object of the present invention. In fact, it is possible to use different materials, with different properties, to realize the support of the luminous direction indicator 100 (for example the cuffs), so that you can have advantages in relation to the comfort or ease required for wearing correctly the device. Therefore, if in the future the materials sector were to make available new materials' technologies, particularly advantageous, in order to implement the present invention more efficiently, further improvements could be made without changing the inventive nature and the principles that inspired the invention itself.

Also the processing flow of the information obtained from the sensors can be conducted according to some variants. With regard to this last aspect, what characterizes the invention is the fact that, starting from information produced by a triaxial accelerometer, however it is oriented, and by an inclinometer integral with said triaxial accelerometer, it is possible to deduce the movements of a hand of a cyclist (or anyone wearing such a device), and it is possible to interpret the meaning of this movement, when this represents the gesture that cyclists normally do to indicate their intention to make a change of direction.

This processing flow can be based on the determination of a Cartesian system (such as that indicated in the detailed description of the present invention), but it can also follow other calculation strategies (for example by constructing a polar reference system), provided that the movement of the hand is described with respect to a reference system associated with the bicycle (or the considered vehicle or, in any case, the direction of travel), taking into account that the orientation (and the position in general) of the triaxial accelerometer 140 cannot be strongly correlated to any reference system associated with the bicycle (or the direction of travel); being the shape of the bicycle handlebars too variable, as well as the position of the hands on them. After all, also the positions with which the runners hold their hands while running (depending on the running style they adopt) are very variable.

Furthermore, more articulated processing flows can be conceived, but optimized from the point of view of containing electricity consumption. In fact, the process of updating the orientation of the reference system associated with the motion of the bicycle can be suspended, even turning-off the sensors that feed the processing, in the event that the cyclist is traveling long and straight routes (for example for a movement of several Km on an extra-urban road), thus obtaining a considerable saving on battery consumption. The decision to suspend this processing, when not necessary, and consequently to reactivate it, when it is needed, can take place in various ways, for example by equipping the luminous direction indicator 100 with a device for self-switching-off when inactivity and self-switching-on when moving. This device can provide for the presence of an additional distinct sensor (and very low consumption): the latter is activated when the main sensors detect a persistent stability of the reference system associated with the bicycle and, therefore, they can be switched off, and said eventual an additional distinct sensor has the task of switching them back on, in case of particular movements indicative of the fact that the regular running is finished.

Said separate sensor, being essentially an accelerometer too, can also be implemented as a special, low-consumption mode of operation of the same accelerometer sensor 140 (for example by reducing its accuracy).

Therefore, said light indicator of direction 100 according to claim 1, is arranged to operate in two modes: a first operating mode in which said calculation means 120 continuously process the information produced by said inclinometer 130 and triaxial accelerometer 140 sensors, to interpret the meaning of the movement of the hand, and a second low-consumption mode in which the aforesaid processing indicated in the previous point is not performed.

Other possible variants for the present invention could be linked to the evolution of electronic technologies in general (which are evolving towards an ever-greater miniaturization and towards an ever-lower power requirement), so that the luminous direction indicator 100 indicated in the invention could, for example, integrate further sensors capable of supporting further applications useful for a cyclist.

Therefore, especially in the context of such evolutionary scenarios, the invention lends itself to incorporating and supporting further development and improvement efforts, capable of improving the performance of the system described. Therefore, many further developments can be made by the man skilled in the art without thereby departing from the scope of the invention as it results from this description and the attached claims which form an integral part of this description; or, if said developments are not included in the present description, they may be the subject of further patent applications associated with the present invention, or dependent on it.

1. A light indicator of direction (100) suitable for being worn by the driver of a vehicle as a wristband or as a glove, and equipped with at least the following components:
a. a lighting element (110) arranged to turn on and off as a function of a suitable electrical command,
b. an electrical power unit (150),
c. a single triaxial accelerometer (140), able to provide a vector signal indicative of the acceleration vector to which said triaxial accelerometer is subjected to,
d. an inclinometer sensor (130), rigidly coupled with said triaxial accelerometer (140), suitable for providing a signal indicative of the inclination of its axis with respect to the vertical direction,
e. computing means (120) capable of processing said signals provided by said triaxial accelerometer (140) and said inclinometer sensor (130), and capable of producing an electrical command for the switching on and off of said lighting element (110);
and said light indicator of direction (100) is characterized in that said computing means (120) are configured for:
executing a calculation program that determines the motion of said vehicle as a function of said signals provided by said single triaxial accelerometer (140) and said inclinometer sensor (130), regardless the movement of the hand of said driver;
executing a calculation program that determines the acceleration (300) to which said triaxial accelerometer is subjected to, as a function of said signals provided by said single triaxial accelerometer (140) and said inclinometer sensor (130), being said acceleration (300) is expressed in a reference system (200) substantially integral with the motion of said vehicle and oriented regardless of the orientation of said triaxial accelerometer (140);
executing a calculation program that generates a switch-on command for said lighting element (110) as a function of said acceleration (300) determined in the previous point “g.”

2. The light indicator of direction (100) according to claim 1, implemented as a wristband integrated into the end of the sleeves of a garment.

3. The light indicator of direction (100) according to claim 1, wherein said reference system (200) oriented regardless of the orientation of said triaxial accelerometer (140) is a Cartesian reference system associated with a vehicle driven by a driver wearing said indicator of direction (100); and said reference system (200) is characterized by an axis “V” oriented like the vertical direction, and an axis “D” lying on the plane determined by the direction of the vertical and the direction of motion of said vehicle, and which results from the shorter rotation of the straight line oriented as the direction of motion of said vehicle until it assumes a direction orthogonal to said “V” axis.

4. The light indicator of direction (100) according to claim 1, wherein said lighting element (110) is a LED lighting device.

5. The light indicator of direction (100) according to claim 1, designed to operate in two modes:
a. a first operating mode, in which said computing means (120) continuously process the information produced by said inclinometer (130) and triaxial accelerometer (140) sensors, in order to interpret the meaning of movement of the hand,
b. a second low consumption mode, in which the processing indicated in the previous point “a” is not performed.

6. The light indicator of direction (100) according to claim 1, designed to be worn by a cyclist.
